(19) United States
(12) Patent Application Publication
(10) Pub. No.: US 2010/0310765 A1
(43) Pub. Date: Dec. 9, 2010

(54) LIQUID DISPENSING SYSTEM AND METHOD

(76) Inventors: Lars Olsson, Tyreso (SE); Christer Ohlin, Varmdo (SE)

Correspondence Address: KENYON & KENYON LLP, ONE BROADWAY, NEW YORK, NY, 10004, US

(21) Appl. No.: 12/867,119

(22) PCT Filed: Feb. 9, 2009
(86) PCT No.: PCT/EP09/51423

§ 371 Date: Aug. 11, 2010

Related U.S. Application Data
(60) Provisional application No. 61/027,517, filed on Feb. 11, 2008.

(30) Foreign Application Priority Data
Feb. 11, 2008 (EP) 08151249.3

(51) Int. Cl. B05D 5/10; B05C 11/00

(52) U.S. Cl. 427/207.1; 118/663

(57) ABSTRACT

A liquid dispensing system and method is provided, that can be shifted between dispensing mode and circulation mode. The system comprises: a tank (1) for liquid; a liquid feeder line (5) from the tank to a discharge opening (10); a pump (2) effective for feeding liquid from the tank for dispensing via the discharge opening at dispensing pressure and dispensing flow; a shifting valve (6) controllable for shifting between dispensing and circulation modes, wherein in circulation mode the liquid is circulated through a return line (8) by the pump (2) in continued operation. The system is characterized by a flow area restriction (7) arranged in the return line (8) and dimensioned to generate in the return flow a drop in pressure substantially equal to a drop in pressure generated by the discharge opening (10) in dispensing mode, maintaining thereby during circulation mode the liquid dispensing system at the corresponding pressure of the dispensing mode.

The present invention relates to a liquid dispensing system, and more specifically to pressure control of a circulating liquid flow in a liquid dispensing system which is shiftable between dispensing mode and circulation mode. Analogously herewith, the invention also relates to a method by which the pressure of a circulating liquid is maintained during a temporary shutdown of a liquid dispensing system.

In the following disclosure of the invention, “liquid” is widely used to define a single component or a multi component liquid system which is suitable for dispensing in industrial processes. For reason of simplicity, the expression “liquid” shall be understood herein to encompass any singular or composite liquid component forming part of a liquid system, such as a binding agent, a hardener, a diluting agent, a solvent, or any other liquid substance incorporated in a liquid system and which is dispensable via one or several discharge openings.

Examples of liquid dispensing systems to which the present invention may be implemented include, but are not limited to, systems for mixing liquids or for applying liquids to a substrate, such as mixers, glue dispensing systems, painting systems, and surface coatings systems in general.

The liquid is typically dispensed via a discharge opening to which the liquid is supplied from tanks or containers via feeder lines. Pumps are operable for feeding the liquid at controllable flow rates from the tank to the discharge opening.

In the case of a glue dispensing system, e.g., a glue component is typically dispensed to a substrate that is arranged to move relative to a nozzle unit, although in the alternative the nozzle unit may be arranged to move relative to a stationary substrate. In either case, the dispensing of glue to the substrates includes repeated shutdowns between each successive substrate in a series production of glued products. When applied in a gluing process, the present invention is useful in most implementations wherein glue and/or another component of an adhesive system is dispensed in a start/stop process. Examples include, but are not limited to, glued laminates, block board, parquet flooring, I-beam production, and others.

Circulation of glue during shutdown is a method applied in practise in order to prevent stagnant volumes and in order to avoid undesired high momentum upon acceleration of a stagnant glue volume in restart. Existing solutions are however all focused on pump control to maintain the circulating flow at operative flow level.

Since the pressure drop over dispensing nozzles in a glue dispensing system usually is high, temporary shutdown of the nozzles results in decreasing pressure in the feeder line in circulation mode. This further leads to a delay during which the pressure needs to be restored before glue is again dispensed through the nozzles at a desired flow rate and pressure in restart of the dispensing cycle.

U.S. Pat. No. 7,040,555 discloses a nozzle unit comprising a return canal through which a glue flow is directed at times when the glue is not being directed to the nozzles. The purpose of the return canal is to provide for the glue to constantly flow within a distribution canal network, preventing clogging in the canal network.

In attempt to reduce a start-up time after stoppage it has been disclosed to maintain a normal dispensing pressure in a glue feeder line by pump control and operation of valves during shutdown. In U.S. Pat. No. 4,420,510, e.g., feeder line pressure is monitored and maintained in a stagnant glue volume during shutdown. A volume of glue remaining in the nozzles at shutdown is returned to a tank via a return line. The return line is however not involved in continued circulation of glue during shutdown. U.S. Pat. No. 4,420,510 is thus neither concerned with flow control during shutdown, nor with pressure control of a circulating flow during shutdown, but is rather concerned merely with the pressure control of a stagnant glue volume upstream of the nozzle unit.

U.S. Pat. No. 4,530,465 discloses a method and device for calibrating a regulated flow spraying apparatus. The flow rate is regulated by a return part of the flow to a storage tank via a line comprising a regulating valve.

Because glue dispensing systems notoriously suffer from variations in dimension of flexible lines and hoses, induced by change in pressure and temperature, fatigue, etc., glue dispensing systems are also typically controlled to dispense excessive amounts of glue upon restart in order to ensure that sufficient glue is applied over the whole substrate.

It is thus an object for the present invention to provide pressure control of a circulating liquid flow, through which dispensing of excessive liquid is avoided and dispensing at appropriate pressure and flow rate is ensured immediately on restart of the dispensing cycle.

This object is achieved in a liquid dispensing system and a liquid dispensing method as described herein.

One aspect of the invention concerns a liquid dispensing system that can be shifted between dispensing mode and circulation mode. The system comprises: a tank for liquid; a liquid feeder line from the tank to a discharge opening; a pump operative for feeding liquid from the tank for dispensing via the discharge opening at dispensing pressure and dispensing flow; a valve controllable for shifting between dispensing and circulation modes, wherein in circulation mode the discharge opening is separated from the liquid flow and the liquid is returned through a return line by the pump in continued operation. The system further comprises by a flow area restriction arranged in the return line and dimensioned to generate in the return flow a drop in pressure substantially equal to a drop in pressure generated by the discharge opening in dispensing mode, maintaining thereby during circulation mode the liquid dispensing system at the corresponding pressure of the dispensing mode.

The invention eliminates the need for pressure build-up and the problem of delay in start-up procedures, since it by maintaining the liquid system pressure during circulation mode is ensured that operable pressure and flow is instantly available when the liquid dispensing system is shifted into dispensing mode.

It is not necessary under all circumstances to maintain identical pressures during circulation and dispensing, but variations up to ±15% or up to ±10% is usually acceptable. Preferably, the pressure drop generated by the flow area restriction in the return line may thus deviate from the pressure drop generated by the discharge opening by up to 15% or up to 10%.

In an embodiment, the flow area restriction is dynamically adjustable in response to a system pressure detected in dispensing mode. The flow area restriction is then realized in the form of a pressure regulating valve which is arranged in the return line and controllable for adjusting the pressure of the circulating liquid in response to pressure detection performed in dispensing mode by a sensor which is arranged in the feeder line that supplies liquid to the discharge opening in dispensing mode. This way, the pressure and flow in circulation mode is continuously adaptable to variations in system parameters, such as a change in viscosity or change of temperature, wear on hoses and equipment, etc.

In embodiment where a liquid dispensing system is arranged for dispensing liquid to a substrate, a sensor for monitoring the passage of substrates relative to a nozzle unit is advantageously provided. The pressure regulating valve is then preferably controllable in response to system reference pressure detected as the trailing end of a substrate passes the monitor sensor. In this way it is ensured that relevant reference values for pressure control are always provided in circulation mode.

A control unit is advantageously arranged for controlling the operation of the pump, the switching of the shifting valve and the throttling of the pressure regulating valve in response to a system reference pressure received in the control unit from the pressure sensor in synchronization with the monitored feed of substrates. The control unit permits operator control for trimming the operation of the liquid dispensing system, and achieves substantial reduction of waste in an embodiment wherein dispensing and circulation modes are synchronized with a monitored feed of substrates. The control unit further provides programmable or operator-controlled shifting between different types of production.

Another aspect of the invention concerns a method for dispensing a liquid comprising continuously operating a liquid feeder pump and shifting between dispensing mode and circulation mode, said dispensing mode comprising feeding liquid from a tank to a discharge opening, said circulation mode comprising disconnecting the liquid from the discharge opening and circulating it back to the tank through a return line provided with a flow area restriction generating a pressure drop substantially equal to the pressure drop generated by the discharge opening. In this way, the liquid may be circulated in circulation mode at a substantially maintained pressure by continued operation of the liquid feeder pump. In dispensing mode, the liquid may be disconnected from the return line.

In an embodiment, the method further comprises the steps of detecting the system pressure in dispensing mode, and in circulation mode dynamically adjusting a flow area of said restriction in response to the detected pressure.

In a method for dispensing liquid to a substrate, the method advantageously comprises the further steps of monitoring the passage of substrates relative to a nozzle unit, and adjusting the flow area of said restriction in response to a system pressure detected upon termination of each dispensing cycle.

In a specific embodiment of the method for dispensing liquid to a substrate, the sequential control of the liquid dispensing system in dispensing and circulation modes can be summarized by comprising the following steps:
monitoring the passage of substrates moving relative to a dispensing nozzle unit;
initiating dispensing of liquid by shifting into dispensing mode close before the passage of a leading end of a substrate;
detecting the pressure in a liquid feeder line to the nozzle unit, and storing in a process control unit, as a reference value, the pressure detected upon passage of a trailing end of a substrate;
shifting into circulation mode by directing the liquid flow into a return line during continued operation of the liquid feeder pump;
comparing the reference value with pressures continuously detected in the feeder line in circulation mode, and adjusting in response thereto the flow area through a pressure regulating valve arranged in the return line.

It has been found, that by controlling the pressure of a circulating liquid during shutdown as disclosed herein, the novel liquid dispensing system and method can avoid excessive dispensing of liquid at initiation of each successive dispensing cycle, and benefit from a reduction of liquid waste by as much as in the order of up to 10% or more of the total liquid consumption.

The invention is applicable for all liquid dispensing systems in which a liquid is dispensed in a process comprising repeated start and stop control, but is particularly advantageous for systems and methods in which the liquid is glue. In an embodiment a glue dispensing system and method may, for example, include cycle times ranging down to tenths of a second both in dispensing and in shutdown, such as 0.1-30 sec dispensing mode and 0.2-60 sec shutdown mode. Feed rate of substrates will usually not exceed one substrate per second, which may be advanced at speeds ranging up to 150 m/min or above. Size of substrates may, for example, include widths of 2-600 mm and lengths of 20-60000 mm. Glue may, for example, be dispensed at an operative pressure of or below 5 bar a and at a flow rate of 5-50000 g/min. Working temperature may be any temperature suitable for the liquid, for example normal room temperature (from about 20 to about 40° C.). The operational parameters given above as examples are useful for glue systems such as those incorporating melamine, urea, formaldehyde, phenol, resorcinol, polyvinyl acetate, etc., among skilled persons often referred to by the abbreviations MUF, MF, UF, PRF, PF and PVAC.

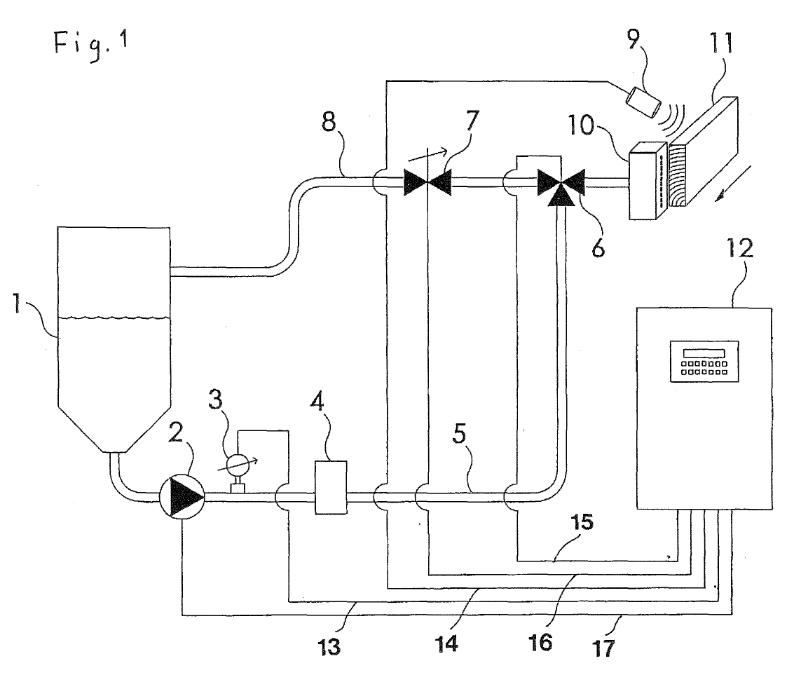

The invention will be further explained below with reference to the accompanying drawing, in which FIG. 1 schematically illustrates a set up of a liquid dispensing system according to an embodiment of the present invention.

FIG. 1 shows the basic components of a liquid dispensing system including a tank 1, a liquid feeder line 5 leading from the tank to a discharge opening 10, a pump 2 feeding liquid from the tank to the discharge opening via the feeder line, and a valve 6 upstream of the discharge opening as seen in the flow direction of liquid. The valve 6 is operable at shutdown to shift the system from dispensing to circulation mode by disconnecting the discharge opening from the liquid flow in order to direct the liquid in a circulating flow via a return line 8, preferably to the tank or another location upstream of an inlet to the pump 2. The shifting valve 6 is advantageously a three-way valve, although other valve configuration or combination of opening/closing valves is possible without changing the essentials of the present invention. Obviously, the valve 6 is likewise operable for shifting the liquid dispensing system back from circulation mode upon start of a dispensing cycle.

According to the invention a restriction 7 is arranged in the return line 8, downstream of the shifting valve 6. The restriction 7 is operative for restricting the flow area of the return line, thus restricting the flow of liquid through the return line 8. The restriction 7 is dimensioned to generate in the return flow a drop in pressure substantially equal to a drop in pressure generated by the discharge opening in dispensing mode. By restricting the flow area in the return line during circulation mode as disclosed, while continuously operating the pump, the liquid dispensing system is maintained at the corresponding pressure and flow of dispensing mode. Since the liquid flow through the discharge opening is more or less directly-proportional to the pressure upstream of the shifting valve, an operative liquid flow is attainable immediately on restart. Thus, by maintaining the dispensing pressure during circulation as taught herein, a boost of system pressure in restart of dispensing mode is no longer required and the system is continuously maintained at a more moderate system pressure.

In this connection it should be pointed out that the return line 8 is dimensioned, with respect to its length and inner diameter, to provide per se a counter pressure which is lower than the lowest operative dispensing pressure in the liquid dispensing system. It should also be pointed out that a liquid dispensing system in practise can be subject to variations in pressure caused by application-specific conditions, and that during operation also the dispensing pressure can vary, or need to be adjusted, to some degree. It is thus not necessary under all circumstances to maintain accurately identical pressures during circulation and dispensing. In order to achieve a technical effect and to benefit from the invention, it will in some applications be sufficient to maintain a pressure in circulation mode which corresponds to about 95-105% of the pressure in dispensing mode. In still other applications, a pressure during circulation corresponding to 90-110% of the pressure in dispensing may be sufficient in order to benefit from the invention. The object of the present invention will thus still be achieved also if in practise the pressure in circulation mode includes pressure variations in the order of 0%-10%, or even more in applications wherein absolute dispensing control is less critical.

Preferably, the restriction is a pressure regulating valve 7 which is dynamically controllable in response to a feeder line pressure detected by a sensor 3 which is arranged in the feeder line 5 upstream of the discharge opening 10 and the shifting valve 6.

Operative flow and dispensing pressure can this way be maintained in a continued liquid flow during shutdown between two successive liquid dispensing cycles. As a dispensing cycle is terminated, the discharge opening 10 is disconnected from the liquid flow by operation of the valve 6. The pump 2 continues to pump the liquid back to the tank 1 via the return line 8 comprising the pressure regulating valve 7. The pressure regulating valve 7 is controlled for adjusting/throttling the flow of circulating liquid in response to continuous pressure detection performed by the sensor 3 arranged in the feeder line 5 supplying liquid to the discharge opening. The pressure regulating valve 7 is set in response to an operative pressure detected in the feeder line during dispensing, and controlled by the sensor 3 to maintain the corresponding pressure in the liquid dispensing system during circulation.

Between dispensing cycles, control of the pressure regulating valve and system pressure can be based on the operative dispensing pressure that is detected during each successive dispensing cycle. Especially, the system may be controlled to maintain the pressure which is detected at the end of each preceding dispensing cycle.

In a system for dispensing liquid to substrates, a sensor 9 may be arranged to monitor the successive feed of substrates 11 relative to the discharge opening 10, the latter in this embodiment realized as a nozzle unit 10 comprising one or several individual nozzles.

The monitoring sensor 9 may be located upstream of the nozzle unit as seen in the feed direction of substrates, at a forward distance or allowance which is accounted for in the pressure detection function. Detected pressure and work flow is supplied to a control unit 12 which coordinates the operation of the valves 6 and 7, as well as the operation of the pump 2, in response to a system reference pressure received from the pressure sensor 3 in synchronization with the monitored feed of substrates.

The flow area of the recycled flow is in other words restricted downstream of the shifting valve 6 in order to control the pressure in the liquid flow upstream of the shifting valve. The pressure drop over the pressure regulating valve 7 should be equal or substantially equal to the loss in pressure caused by the nozzle unit in dispensing cycles, this way maintaining the corresponding pressure in both dispensing and circulation modes.

A corresponding pressure control may alternatively be achieved by means of a static restriction inserted in the return flow. A dynamically controlled restriction provides however the additional advantage of a flexible system that is readily adaptable to changes in operation parameters such as temperature, wear, exchange of system parts and equipment, shifting between different types of liquid having different viscosities, etc., and is therefore the preferred embodiment.

An appreciable advantage provided by the present invention is that the operative parts built into the liquid dispensing system can be off the shelf equipment familiar to the skilled person. In the case of dispensing liquid to substrates, the discharge opening can be any type of dispensing unit, although typically the dispensing unit would comprise at least one individual nozzle or a set of individual nozzles effective for applying parallel strings or a mist of liquid onto a liquid receiving substrate. Hoses, clamps, etc., are those typically applied in liquid dispensing systems. A suitable shifting valve 6 may be any fast operating three-way valve that essentially avoids any pumping effect in closing and opening movements, although other types of valves or combination of valves are possible. A suitable pressure regulating valve 7 may be any continuously variable valve that can be precisely controlled. The pressure sensor 3 is preferably a high resolution sensor, communicating digitally through a communications protocol or via analogous signals. The monitor sensor 9 can be a photo sensor, a laser light sensor, an ultra sound sensor or any other fast reacting sensor. A suitable pump 2 may in most cases be a positive displacement pump delivering constant flow volumes per stroke or revolution, albeit any type of pump which is controllable and capable of providing the subject pressures and desired flow capacities will be useful.

The control unit 12 usually comprises a processor receiving data from pressure and monitoring sensors 3 and 9 via input lines 13 and 14, respectively. Based on the data input, the processor generates corresponding control data that control the operation of the shifting valve 6, the pressure regulating valve 7 and the pump 2, via output lines 15, 16 and 17 respectively. The processor comprised in the control unit 12 may be a computer arranged for operator's control via a keyboard and a display that is accessible from the control unit's exterior. The processor of control unit 12 may further be arranged for execution of a software product, programmable via the keyboard or via an external computer, and stored on a computer readable medium that is insertable or otherwise connectable to the control unit 12.

The sequential operation of the liquid dispensing system is initiated by the output of a signal from the control unit 12 that effects switching of the valve 6 into dispensing mode. During dispensing, the detected pressure in feeder line 5 is continuously received in the control unit. Optionally, a flow-meter 4 may be arranged for input also of flow rate data to the control unit, in both dispensing and circulation modes. The operation of the pump 2 is controlled for maintaining the operative flow and pressure in response to this input data. The passage of substrates onto which liquid is to be dispensed, in a corresponding implementation of the invention, is monitored by the sensor 9 by which the passage of a substrate's trailing end is detected and registered in the control unit 12. The current pressure in feeder line 5 is then registered as a reference value in the control unit. In effect of the forward location of the monitor sensor 9, dispensing continues for a time which is determined by the distance between the monitoring sensor's location and the dispensing nozzle unit on one hand, and by the relative velocity of substrates on the other hand. With a corresponding delay in time, the control unit switches the shifting valve 6 into shutdown/circulation mode, directing the liquid into a circulating flow via the return line 8. In the circulation mode, pressure detection and pump control is continued. If the detected pressure level in the feeder line falls below the reference value, the control unit operates the pressure regulating valve 7 in a closing direction to reduce the flow area in the return line 8 correspondingly. In the reverse, the control unit operates the pressure regulating valve 7 in an opening direction to increase the flow area in the return line 8 correspondingly should the detected pressure level in the feeder line rise above the reference value. The feed-back control of the pressure regulating valve 7 and the pump 2 continues until the leading end of a following substrate is detected by the monitoring sensor 9, whereby a new dispensing cycle is initiated after the corresponding delay in time.

Disclosed herein is an example of a set up of a liquid dispensing system, to which modifications of the detailed design and set up are possible within the scope of the claims defining the novel solution.

Albeit the present invention is disclosed in part as a system adapted for dispensing liquid to substrates via a nozzle unit, it will be realized that this embodiment is merely one of several useful applications of the invention. Other conceivable applications to be mentioned include, e.g.:
dispensing of liquid components for mixing, wherein the discharge opening communicates with the inlet to a mixer, either it be a static mixer or any kind of driven mixer apparatus;
dispensing of liquid components for the charge of liquid containers within, e.g., the pharmaceutical and foodstuff industries;
dispensing of liquid components such as fuel/propellant, or an inhibitor or a catalyst into chemical or combustion processes;
dispensing of liquid components, such as liquid polymers, in injection moulding processes, and others.

Conclusively, the liquid dispensing system and method of the present inventions may find general use in any liquid dispensing process which is characterized by repeated start and stop operation and high demands for accuracy.

1. A liquid dispensing system that can be shifted between dispensing mode and circulation mode, the system comprising:
a tank for a liquid;
a liquid feeder line from the tank to a discharge opening;
a pump operative for feeding liquid from the tank for dispensing via the discharge opening at dispensing pressure and flow;
a valve controllable for shifting between dispensing and circulation modes, wherein in circulation mode the discharge opening is separated from the liquid flow and the liquid is circulated through a return line by the pump in continued operation, a flow area restriction arranged in the return line and dimensioned to generate in the return flow a drop in pressure substantially equal to a drop in pressure generated by the discharge opening in dispensing mode, maintaining thereby in circulation mode the liquid dispensing system at the corresponding pressure of the dispensing mode.

2. The liquid dispensing system as claimed in claim 1, wherein the flow area restriction is dynamically adjustable in response to a system pressure detected in dispensing mode.

3. The liquid dispensing system as claimed in claim 2, wherein the flow area restriction is a pressure regulating valve arranged in the return line, the pressure regulating valve being controllable for adjusting the liquid system pressure in response to pressure detection performed by a pressure sensor arranged in the liquid feeder line supplying liquid to the discharge opening in dispensing mode.

4. The liquid dispensing system as claimed in claim 3, the system being arranged for dispensing liquid to a substrate and further comprising a monitoring sensor monitoring the passage of substrates relative to a nozzle unit wherein the pressure regulating valve is controllable in response to a system reference pressure which is registered as a trailing end of a substrate passes the monitoring sensor.

5. The liquid dispensing system as claimed in claim 4, further comprising a control unit controlling the operation of the pump, the switching of the valve and the throttling of the pressure regulating valve in response to a system reference pressure received in the control unit from the pressure sensor in synchronization with the monitored feed of substrates.

6. The liquid dispensing system as claimed in claim 1, wherein the pressure drop generated by the flow area restriction in the return line deviates from the pressure drop generated by the discharge opening by no more than up to 15%.

7. The liquid dispensing system as claimed in claim 1, wherein the liquid is glue.

8. A method for dispensing a liquid comprising continuously operating a liquid feeder pump and shifting between dispensing mode and circulation mode, said dispensing mode comprising feeding liquid from a tank to a discharge opening, said circulation mode comprising disconnecting the liquid from the discharge opening and circulating it back to the tank through a return line provided with a flow area restriction generating a pressure drop substantially equal to a the pressure drop generated by the discharge opening.

9. The method as claimed in claim 8, further comprising the steps of detecting a system pressure in dispensing mode, and in circulation mode dynamically adjusting a flow area through said flow area restriction in response to the detected pressure.

10. The method as claimed in claim 8, further comprising dispensing the liquid to substrates, and monitoring the passage of substrates relative to a nozzle unit, and adjusting the flow area through said flow area restriction in response to a system pressure detected close to termination of each dispensing cycle.

11. The method as claimed in claim 8, further comprising the steps of:
monitoring the passage of substrates moving past a dispensing nozzle unit;
initiating dispensing of liquid by switching a valve into dispensing mode upon the passage of a leading end of a substrate;
detecting the pressure in a liquid feeder line to the nozzle unit, and storing in a process control unit, as a reference value, the pressure detected upon passage of a trailing end of a substrate;
shifting into circulation mode by switching the valve for directing the liquid flow into a return line during continued operation of a liquid feeder pump;
comparing the reference value with pressures continuously detected in the feeder line in circulation mode, and adjusting in response thereto the flow area through a pressure regulating valve arranged in the return line.

12. The method as claimed in claim 8, wherein the pressure drop generated by the flow area restriction in the return line deviates from the pressure drop generated by the discharge opening by no more than up to 15%.

13. The method as claimed in claim 8, wherein the liquid is glue.

14. The liquid dispensing system as claimed in claim 5, wherein the pressure drop generated by the flow area restriction in the return line deviates from the pressure drop generated by the discharge opening by no more than up to 15%.

15. The liquid dispensing system as claimed in claim 6, wherein the liquid is glue.

16. The method as claimed in claim 9, further comprising dispensing the liquid to substrates, and monitoring the passage of substrates relative to a nozzle unit, and adjusting the flow area through said flow area restriction in response to a system pressure detected close to termination of each dispensing cycle.

17. The method as claimed in claim 9, further comprising the steps of:
monitoring the passage of substrates moving past a dispensing nozzle unit;
initiating dispensing of liquid by switching a valve into dispensing mode upon the passage of a leading end of a substrate;
detecting the pressure in a liquid feeder line to the nozzle unit, and storing in a process control unit, as a reference value, the pressure detected upon passage of a trailing end of a substrate;
shifting into circulation mode by switching the valve for directing the liquid flow into a return line during continued operation of a liquid feeder pump;
comparing the reference value with pressures continuously detected in the feeder line in circulation mode, and adjusting in response thereto the flow area through a pressure regulating valve arranged in the return line.

18. The method as claimed in claim 11, wherein the pressure drop generated by the flow area restriction in the return line deviates from the pressure drop generated by the discharge opening by no more than up to 15%.

19. The method as claimed in claim 10, wherein the liquid is glue.

20. The method as claimed in claim 12, wherein the liquid is glue.
